(19) United States
(12) Patent Application Publication
(10) Pub. No.: US 2025/0365058 A1
(43) Pub. Date: Nov. 27, 2025

(54) METHOD AND APPARATUS FOR PAIRING BEAMS IN WIRELESS COMMUNICATION SYSTEM SUPPORTING SIDELINK COMMUNICATION

(71) Applicants: HYUNDAI MOTOR COMPANY, Seoul (KR); KIA CORPORATION, Seoul (KR); GACHON UNIVERSITY INDUSTRY-ACADEMIC COOPERATION FOUNDATION, Seongnam-si (KR)

(72) Inventors: Ui Hyun Hong, Hwaseong-si (KR); Hyuk Min Son, Seoul (KR)

(73) Assignees: HYUNDAI MOTOR COMPANY, Seoul (KR); KIA CORPORATION, Seoul (KR); GACHON UNIVERSITY INDUSTRY-ACADEMIC COOPERATION FOUNDATION, Seongnam-si (KR)

(21) Appl. No.: 18/873,728

(22) PCT Filed: Jun. 13, 2023
(86) PCT No.: PCT/KR2023/008098

§ 371 Date: Dec. 10, 2024

(30) Foreign Application Priority Data
Jun. 13, 2022 (KR) 10-2022-0071655

(51) Int. Cl. H04B 7/06; H04W 72/044; H04W 72/25

(52) U.S. Cl. CPC H04B 7/0696; H04W 72/046; H04W 72/25

(57) ABSTRACT

A method for a first user equipment (UE), according to the present disclosure, comprises the steps of: beam sweeping a first physical sidelink control channel (PSCCH) including beam identification information and physical sidelink feedback channel (PSFCH) resource information, and transmitting same to a second UE; receiving the PSFCH from the second UE on the basis of the PSFCH resource information; pairing beams by determining, on the basis of transmission beam indication information included in the received PSFCH and a beam by which the PSFCH is received, a transmission beam and a reception beam to be used for sidelink communication; and sidelink-communicating with the second UE through the paired beams.

### TECHNICAL FIELD

The present disclosure relates to a sidelink communication technique, and more particularly, to a beam pairing technique in sidelink communication.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, in environments where data transmission and reception are carried out using multiple beams in a high-frequency band such as the FR2 band, physical sidelink control channel (PSCCH) monitoring is required for sidelink communication. For effective PSCCH monitoring, once a transmitting user equipment (TX-UE) and a receiving user equipment (RX-UE) receive synchronization signals and establish beam pairing, the RX-UE can attempt to receive a PSCCH. If a beam pairing operation occurs during the synchronization signal transmission and reception process, the RX-UE needs to attempt to receive synchronization signals from a specific TX-UE to receive data from that TX-UE, even if it has already acquired synchronization from another source. In such cases, the RX-UE needs to perform a beam pairing process based on beam information obtained from the specific TX-UE's synchronization signals. Attempting to receive synchronization signals from the specific TX-UE for beam pairing may introduce inefficiencies due to delays in data transmission and reception. Therefore, methods need to be developed that allow the RX-UE, which has already acquired synchronization, to monitor PSCCHs without being in a beam-paired state with the specific TX-UE.

### DISCLOSURE

### Technical Problem

The present disclosure is directed to providing a method and an apparatus for beam pairing in sidelink communication.

### Technical Solution

A method of a first user equipment (UE), according to a first exemplary embodiment of the present disclosure for achieving the above-described objective, may comprise: transmitting a first physical sidelink control channel (PSCCH) to a second UE in a beam sweeping scheme, the first PSCCH including beam identification information and physical sidelink feedback channel (PSFCH) resource information; receiving a PSFCH from the second UE based on the PSFCH resource information; performing beam pairing by determining a transmission beam and a reception beam to be used for sidelink communication based on transmission beam indication information included in the received PSFCH and a beam through which the PSFCH is received; and performing sidelink communication with the second UE through the transmission beam and the reception beam which are paired through the beam pairing.

The PSFCH resource information may include mapping information between each beam of the first UE and one reserved PSFCH resource or mapping information between beams of the first UE and one reserved PSFCH resource.

The beam sweeping scheme may be performed based on beam sweeping configuration information including at least one of a number of times of performing beam sweeping or a periodicity at which the beam sweeping is performed.

The transmission beam indication information may include information of bit(s) corresponding to an index for identifying a beam through which the first PSCCH is transmitted or a sequence for identifying a beam through which the first PSCCH is received.

The method may further comprise: transmitting data to be transmitted to the second UE through a physical sidelink shared channel (PSSCH) using all of beams being swept.

The method may further comprise: in response to an error existing in the received PSFCH, transmitting a second PSCCH to the second UE in a beam sweeping scheme using a greater number of beams than a previous period based on beam sweeping configuration information.

The method may further comprise: checking a number of beam sweeping resources and a number of beams to be swept; in response to the number of the beam sweeping resources being smaller than the number of the beams to be swept, dividing the beams to be swept into a plurality of groups based on the beam sweeping resources; and transmitting the first PSCCH to the second UE by sequentially performing beam sweeping using the respective plurality of groups through the beam sweeping resources.

A method of a first user equipment (UE), according to a second exemplary embodiment of the present disclosure for achieving the above-described objective, may comprise: determining a beam sweeping resource for a first physical sidelink control channel (PSCCH #1) and a first physical sidelink shared channel (PSSCH #1) to be transmitted to a second UE; determining a transmission resource to have a same time resource as at least some symbols of a sidelink synchronization signal block (S-SSB) transmitted using the determined beam sweeping resource in a beam sweeping scheme; and transmitting the PSCCH #1 and the PSSCH #1 to the second UE in the determined transmission resource in a beam sweeping scheme,
wherein a beam for transmitting the PSCCH #1 and the PSSCH #1 is same as a beam for transmitting symbols of the S-SSB.

The transmission resource may be composed of symbols excluding symbols in which a synchronization signal is transmitted among the symbols of the S-SSB.

When the first UE is not a UE transmitting the S-SSB, the PSCCH #1 and the PSSCH #1 may be transmitted to the second UE using a same frequency resource as the S-SSB.

The method may further comprise: in response to existence of a PSCCH #2 and PSSCH #2 to be transmitted to a third UE, determining a second transmission resource of the PSCCH #2 and the PSSCH #2 so as to have a same time resource as one or more symbols that do not correspond to the PSCCH #1 and the PSSCH #1 among the symbols of the S-SSB; and transmitting the PSCCH #2 and the PSSCH #2 to the third UE using the second transmission resource,
wherein a beam for transmitting the PSCCH #2 and the PSSCH #2 is same as a beam through which the S-SSB is transmitted.

The method may further comprise: in response to a number of required transmissions of the PSCCH #1 and the PSSCH #1 being greater than a number of S-SSBs, transmitting the PSCCH #1 and the PSSCH #1 by performing additional beam sweeping in a time resource different from transmission resources for S-SSBs.

In the additional beam sweeping for the PSCCH #1 and the PSSCH #1, a beam width and a beam direction may be determined based on values set in a dedicated resource set allocated for transmission of the PSCCH #1 and the PSSCH #1.

Two or more different beams may be configured as additional beams for the additional beam sweeping for the PSCCH #1 and the PSSCH #1.

A first user equipment (UE), according to a first exemplary embodiment of the present disclosure for achieving the above-described objective, may comprise a processor, and the processor causes the first UE to perform:
transmitting a first physical sidelink control channel (PSCCH) to a second UE in a beam sweeping scheme, the first PSCCH including beam identification information and physical sidelink feedback channel (PSFCH) resource information; receiving a PSFCH from the second UE based on the PSFCH resource information; performing beam pairing by determining a transmission beam and a reception beam to be used for sidelink communication based on transmission beam indication information included in the received PSFCH and a beam through which the PSFCH is received; and performing sidelink communication with the second UE through the transmission beam and the reception beam which are paired through the beam pairing.

The PSFCH resource information may include mapping information between each beam of the first UE and one reserved PSFCH resource or mapping information between beams of the first UE and one reserved PSFCH resource.

The beam sweeping scheme may be performed based on beam sweeping configuration information including at least one of a number of times of performing beam sweeping or a periodicity at which the beam sweeping is performed.

The transmission beam indication information may include information of bit(s) corresponding to an index for identifying a beam through which the first PSCCH is transmitted or a sequence for identifying a beam through which the first PSCCH is received.

The processor may further cause the first UE to perform: transmitting data to be transmitted to the second UE through a physical sidelink shared channel (PSSCH) using all of beams being swept.

The processor may further cause the first UE to perform: checking a number of beam sweeping resources and a number of beams to be swept; in response to the number of the beam sweeping resources being smaller than the number of the beams to be swept, dividing the beams to be swept into a plurality of groups based on the beam sweeping resources; and transmitting the first PSCCH to the second UE by sequentially performing beam sweeping using the respective plurality of groups through the beam sweeping resources.

### Advantageous Effects

According to the present disclosure, sidelink communication can be performed between a transmitting node and a receiving node without a need for beam pairing. In particular, the transmitting node can quickly transmit data to the receiving node even if beam pairing has not been pre-established for sidelink communication. Additionally, by not performing a separate beam pairing procedure, data transmission efficiency can be increased.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram for describing a case where a TX-UE transmits a PSCCH in a beam sweeping manner within a specific resource region according to the present disclosure.

FIG. 10 is a conceptual diagram for describing a case where a TX-UE transmits a PSCCH in a beam sweeping manner within a specific resource region according to another exemplary embodiment of the present disclosure.

FIG. 11 is a conceptual diagram illustrating a case where a TX-UE transmits a PSCCH or PSCCH+PSSCH in a beam sweeping manner within a specific resource region according to yet another exemplary embodiment of the present disclosure.

FIG. 12 is a diagram illustrating a structure of an S-SSB with a normal CP according to the 3GPP NR standards.

FIG. 13 is a conceptual diagram for describing a case where a TX-UE transmits a PSCCH+PSSCH using a part of a time interval for S-SSB transmission according to an exemplary embodiment of the present disclosure.

FIG. 14 is a conceptual diagram for describing a case where a TX-UE that does not transmit S-SSB transmits a PSCCH+PSSCH according to an exemplary embodiment of the present disclosure.

FIG. 15 is a conceptual diagram for describing a case of transmitting a PSCCH+PSSCH by beam sweeping in the same manner as S-SSB beam sweeping according to an exemplary embodiment of the present disclosure.

FIG. 16 is a conceptual diagram for describing a case where one TX-UE transmits two different PSCCH+PSSCHs according to an exemplary embodiment of the present disclosure.

FIG. 17 is a conceptual diagram for describing a case where different TX-UEs respectively transmit PSCCH+PSSCHs according to an exemplary embodiment of the present disclosure.

FIG. 18 is a conceptual diagram for describing a case of transmitting a PSCCH+PSSCH through a combination of S-SSB resource regions and specific PSCCH+PSSCH transmission resources according to an exemplary embodiment of the present disclosure.

FIG. 19 is a conceptual diagram for describing a case of transmitting a PSCCH+PSSCH through a combination of S-SSB resource regions and specific PSCCH+PSSCH transmission resources according to another exemplary embodiment of the present disclosure.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

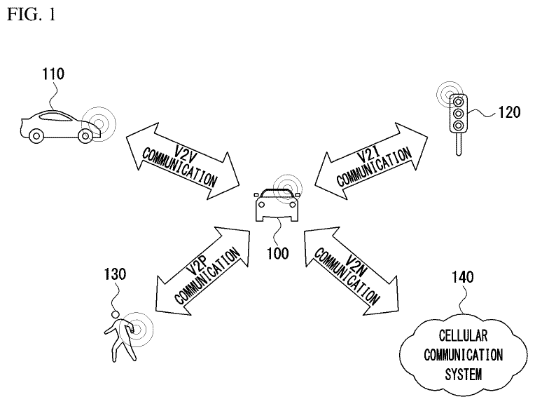

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g. communication network) 140, and the V2X communications supported by the communication system 140 may be referred to as ‘Cellular-V2X (C-V2X) communications’. Here, the communication system 140 may include the 4G communication system (e.g. LTE communication system or LTE-A communication system), 5G communication system (e.g. NR communication system), and the like.

The V2V communications may include communications between a first vehicle 100 (e.g. a communication node located in the vehicle 100) and a second vehicle 110 (e.g. a communication node located in the vehicle 110). Various driving information such as velocity, heading, time, position, and the like may be exchanged between the vehicles 100 and 110 through the V2V communications. For example, autonomous driving (e.g. platooning) may be supported based on the driving information exchanged through the V2V communications. The V2V communications supported by the communication system 140 may be performed based on sidelink communication technologies (e.g. Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g. road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g. ProSe and D2D communication technologies, and the like). In this case, the communications between the vehicle 100 and the infrastructure 120 may be performed using at least one sidelink channel.

The V2P communications may include communications between the first vehicle 100 (e.g. the communication node located in the vehicle 100) and a person 130 (e.g. a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g. ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g. the communication node located in the vehicle 100) and the communication system (e.g. communication network) 140. The V2N communications may be performed based on the 4G communication technology (e.g. LTE or LTE-A specified as the 3GPP standards) or the 5G communication technology (e.g. NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

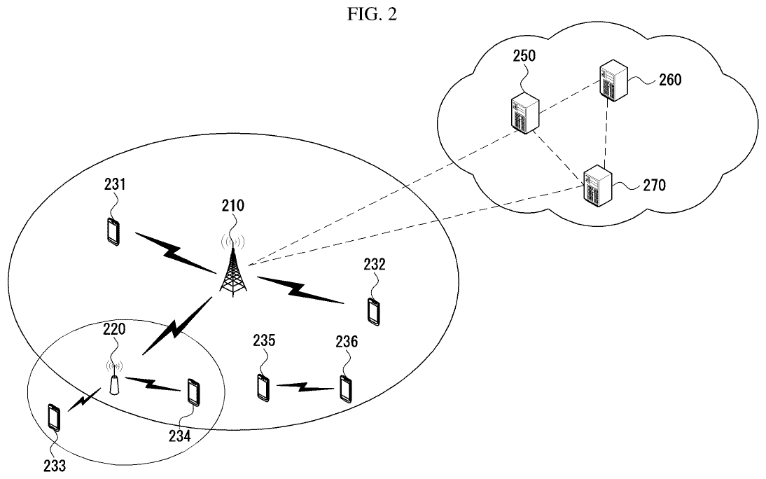

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g. a V2V network slice, a V2I network slice, a V2P network slice, a V2N network slice, etc.) may be configured, and the V2X communications may be supported through the V2X network slices configured in the core network.

The communication nodes (e.g. base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g. base station, relay, UE, S-GW, P-GW, MME, UPF, SMF, AMF, etc.) constituting the communication system may be configured as follows.

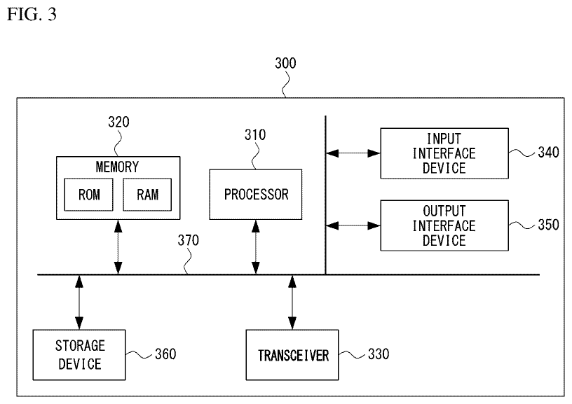

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g. single user (SU)-MIMO, multi-user (MU)-MIMO, massive MIMO, etc.), coordinated multipoint (COMP) communication technologies, carrier aggregation (CA) communication technologies, unlicensed band communication technologies (e.g. Licensed Assisted Access (LAA), enhanced LAA (eLAA), etc.), sidelink communication technologies (e.g. ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

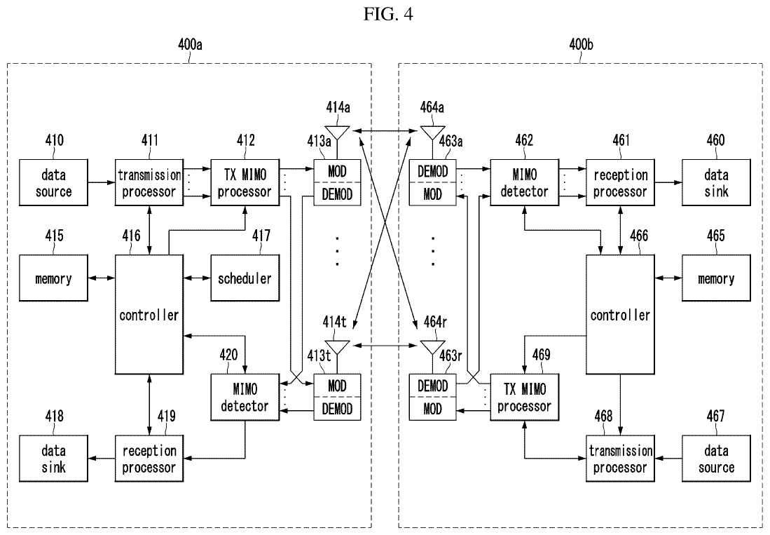

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

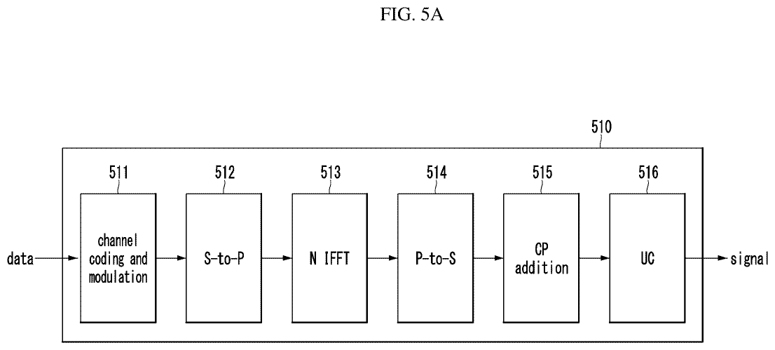

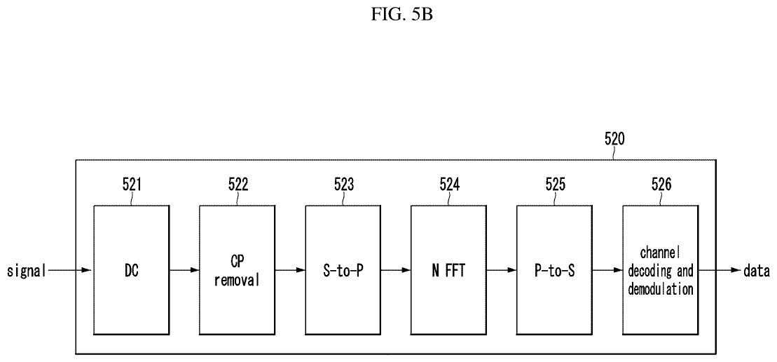

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g. ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g. the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of base station |
| | base station 210 | 210 |
| B | In coverage of | Out of coverage of base station |
| | base station 210 | 210 |
| C | In coverage of | In coverage of base station 210 |
| | base station 210 | |
| D | In coverage of | In coverage of other base station |
| | base station 210 | |

Meanwhile, a user plane protocol stack of the UEs (e.g. the UEs 235 and 236) performing sidelink communications may be configured as follows.

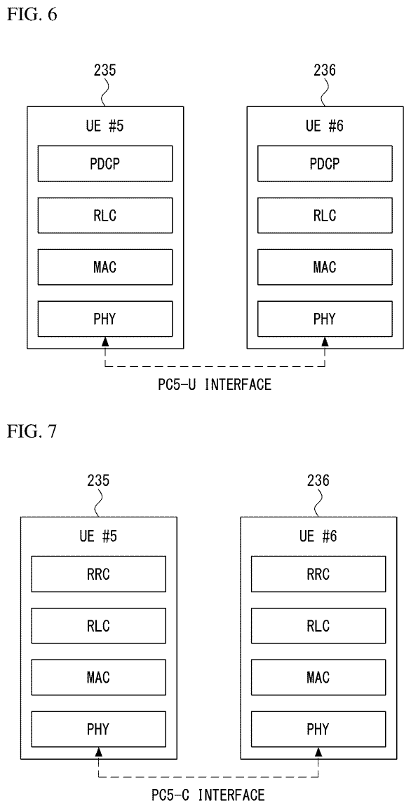

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g. PC5-U interface). A layer-2 identifier (ID) (e.g. a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g. the UEs 235 and 236) performing sidelink communications may be configured as follows.

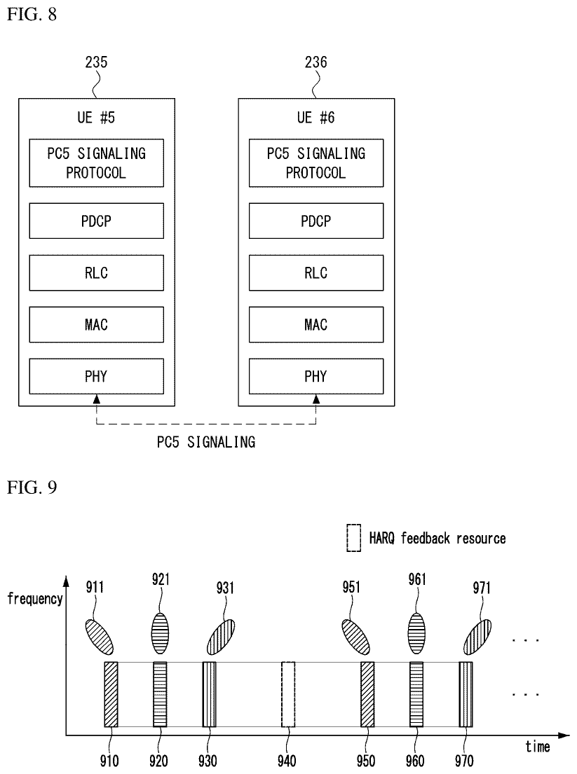

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g. Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g. PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g. UE 235 or 236) by higher layer signaling. The PSCCH may be used for transmitting and receiving sidelink control information (SCI) and may also be configured in the UE (e.g. UE 235 or 236) by higher layer signaling.

The PSDCH may be used for a discovery procedure. For example, a discovery signal may be transmitted over the PSDCH. The PSBCH may be used for transmitting and receiving broadcast information (e.g. system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base |
| | station |
| 3 | Transmission using resources scheduled by base station in V2X |
| | communications |
| 4 | UE autonomous transmission without scheduling of base |
| | station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g. a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g. UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g. UE 235 or 236) within the resource pool configured by the dedicated RRC signaling procedure or the broadcast RRC signaling procedure.

Hereinafter, sidelink communication methods will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a UE #1 (e.g. vehicle #1) is described, a UE #2 (e.g. vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g. SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g. SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g. SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g. sidelink data transmission, sidelink-shared channel (SL-SCH) transmission) may be performed based on one SCI (e.g. 1st-stage SCI). When the multi-SCI scheme is used, data transmission may be performed using two SCIs (e.g. 1st-stage SCI and 2nd-stage SCI). The SCI(s) may be transmitted on a PSCCH and/or a PSSCH. When the single-SCI scheme is used, the SCI (e.g. 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, in the 3GPP standardization meeting, RAN plenary #95e summarized sidelink standardization as follows.

Study and specify enhanced sidelink operations in FR2 licensed spectrum [RAN1, RAN2, RAN4] (this part of the work is on hold until further confirmation in RAN #97).
Update the evaluation methodologies for commercial deployment scenarios
The work is limited to supporting sidelink beam management (including initial beam pairing, beam maintenance, and beam failure recovery) by reusing the existing sidelink CSI framework where possible and reusing the Uu beam management concept.
Beam management in FR2 licensed spectrum considers only sidelink unicast communication.

In the present disclosure described below, it is assumed that synchronization acquisition operations are based on the 3GPP NR sidelink-based synchronization acquisition method. In other words, a transmitting node may transmit synchronization signals in a beam sweeping manner, and a receiving user equipment (RX-UE) may acquire synchronization from a synchronization source with a higher priority among surrounding synchronization sources.

When the synchronization source is a UE, if a transmitting UE (TX-UE) transmits a synchronization signal through a specific beam, and an RX-UE receives the synchronization signal, the RX-UE may obtain information on a transmission beam (TX-beam) of the TX-UE, which both the TX-UE and RX-UE can use for SL communication. The information on the TX-beam may be delivered from the RX-UE to the TX-UE afterward. The TX-UE and the RX-UE may use the beam to perform SL communication with each other. The exchange process for such beam information may be performed in a manner similar to the RACH process in NR FR2.

The above-described mutual acquisition of information on the beam used by the TX-UE and the RX-UE for SL communication may be defined as beam pairing. In addition to the scheme of using synchronization signals, other methods are also possible for initial beam pairing. The present disclosure proposes beam pairing methods for SL communication between a TX-UE and an RX-UE that have not performed initial beam pairing. The methods described in the present disclosure may be applied and used for updating beam information or beam management after initial beam pairing. Alternatively, they may be applied to reattempt beam pairing for SL communication in the event of a beam failure.

All contents of the present disclosure described below may correspond to operations when beam pairing is not performed between a TX-UE and an RX-UE. In other words, the operations may be performed when specific control information or both control information and data need to be transmitted in a state where beam pairing is not performed between a TX-UE and an RX-UE.

### [Beam Sweeping-Based PSCCH+PSSCH Transmission Method for Beam Pairing]

FIG. 9 is a conceptual diagram for describing a case where a TX-UE transmits a PSCCH in a beam sweeping manner within a specific resource region according to the present disclosure.

As shown in FIG. 9, the horizontal axis represents time resources and the vertical axis represents frequency resources. A plurality of resources 910, 920, 930, 940, 950, 960, and 970, each of which is a time and frequency resource, are illustrated. In the following description, each of the resources 910 to 970 will be referred to as the first resource 910 to the seventh resource 970 in the order illustrated in FIG. 9.

According to the present disclosure, as illustrated in FIG. 9, a TX-UE may repeatedly transmit either a PSCCH or both a PSCCH and PSSCH using three beams: 911, 921, and 931. In the following description, a case in which a PSCCH and a PSSCH are transmitted together is denoted as ‘PSCCH+PSSCH’ for convenience.

Describing the case of FIG. 9 in more detail, the TX-UE may perform beamforming on the first resource 910 in a first direction to transmit the PSCCH or PSCCH+PSSCH through the first beam 911, may perform beamforming on the second resource 920 in a second direction to transmit the PSCCH or PSCCH+PSSCH through the second beam 921, and may perform beamforming on the third resource 930 in a third direction to transmit the PSCCH or PSCCH+PSSCH through the third beam 931.

In this case, the resources for transmitting the PSCCH and/or PSSCH may be referred to as ‘beam sweeping resource’, and may be resources allocated or reserved by a base station, or resources selected or reserved by the TX-UE. The resources allocated or reserved by the base station will be further described below. In addition, in the following description, for convenience of description, the consecutive time and/or frequency resources configured to transmit the PSCCH or PSCCH+PSSCH by beam sweeping will be referred to as ‘beam sweeping resource’.

Accordingly, the TX-UE may repeatedly transmit the PSCCH or PSCCH+PSSCH using the first beam 911 to the third beam 931, respectively. The TX-UE illustrated in FIG. 9 transmits the PSCCH or PSCCH+PSSCH by performing the beam sweeping twice. However, it should be noted that the example of FIG. 9 is intended to describing a scheme of transmitting the PSCCH or PSCCH+PSSCH by beam sweeping, and does not limit the number of beam sweepings.

When the TX-UE transmits the PSCCH or PSCCH+PSSCH according to the present disclosure, the PSCCH or PSCCH+PSSCH may be transmitted at regular time intervals. In other words, after a predetermined time elapses from a time when the TX-UE transmits the PSCCH or PSCCH+PSSCH in the beam sweeping manner using the first resource 910, the second resource 920, and the third resource 930, the TX-UE may transmit the PSCCH or PSCCH+PSSCH in the beam sweeping manner using the fifth resource 950, the sixth resource 960, and the seventh resource 970. In FIG. 9, since the TX-UE transmits the PSCCH or PSCCH+PSSCH in three beam directions, it should be noted that the beams required for beam sweeping are composed of three beams 911, 921, and 931.

A constant time offset for the next beam sweeping after one beam sweeping may be set and operated in form of a beam sweeping time-offset value or a beam sweeping periodicity value. For example, the time-offset value or the periodicity value may be set in a resource unit such as a symbol or a slot. Alternatively, the time-offset value or the periodicity value may also be set in a time unit such as milliseconds (ms).

The number of times the TX-UE transmits the PSCCH or PSCCH+PSSCH by beam sweeping according to the present disclosure and the values of the beam sweeping time-offset, the beam sweeping periodicity value, etc. may be set by higher layer signaling such as MAC-CE, RRC, S-SIB, and S-MIB. Through this, the RX-UE, which is a receiving communication node, may receive the PSCCH or PSCCH+PSSCH transmitted by the TX-UE in the beam sweeping manner based on the higher layer signaling.

The number of times the TX-UE transmits the PSCCH or PSCCH+PSSCH by beam sweeping, the beam sweeping time-offset, the beam sweeping periodicity, etc. described above will be collectively referred to as ‘beam sweeping configuration information’.

Meanwhile, a PSCCH may be transmitted without a PSSCH in a standalone form. Alternatively, a PSCCH and a PSSCH corresponding to the PSCCH may be transmitted together. When a PSCCH is transmitted in a standalone form, configuration information for a PSFCH resource for a HARQ feedback corresponding to the PSCCH may be transmitted as being included in the PSCCH. When a PSCCH and a PSSCH corresponding to the PSCCH are transmitted together, the PSCCH may include configuration information for a PSFCH resource for a HARQ feedback for the PSSCH. The PSSCH may be transmitted including some information required for beam pairing. The information required for beam pairing may include, for example, beam identification information for beam identification. The beam identification information will be further described using Tables 3 to 7 below.

FIG. 9 illustrates a PSFCH resource 940 for a HARQ feedback corresponding to the PSCCH or for a HARQ feedback for the PSCCH+PSSCH.

In the present disclosure described below, for convenience of description, it is assumed that the PSCCH and PSSCH are transmitted together in the beam sweeping manner. In addition, for convenience of description, the PSCCH and the PSSCH corresponding to the PSCCH, which are transmitted in the beam sweeping manner, will be referred to as ‘PSCCH+PSSCH’.

As illustrated in FIG. 9, the RX-UE that receives the PSCCH or PSCCH+PSSCH through a specific transmission beam (TX-beam) may indicate to the TX-UE that the RX-UE has successfully received the PSCCH+PSSCH through the specific TX-beam by transmitting a HARQ feedback for reception of the PSCCH or PSCCH+PSSCH.

The case where the RX-UE transmits the above indication may correspond to a case where the RX-UE has received beam pairing information and the PSFCH transmitted from the TX-UE through the PSCCH. In this case, the PSCCH received by the RX-UE may include all or part of PSFCH resource configuration information for the HARQ feedback. In other words, the PSFCH may be used by configuring the PSFCH resource by cell-specific or resource pool (RP)-specific higher layer signaling such as MAC-CE, RRC, S-SIB, or S-MIB. As another example, a specific time and frequency resource for the PSFCH may be reserved through the PSCCH. As yet another example, a part of the PSFCH resource information may be configured by higher layer signaling such as MAC-CE, RRC, S-SIB, or S-MIB, and the remaining PSFCH resource information may be explicitly or implicitly indicated through the PSCCH. In all exemplary embodiments of the present disclosure described below, the PSFCH resource may be configured in one of the manners described above.

Methods for allocating a PSFCH resource according to the present disclosure will be described.

As described above, the TX-UE may transmit the PSCCH or PSCCH+PSSCH through the respective beams. Therefore, a sidelink system according to the present disclosure may configure PSFCH resource(s) for the PSCCH or PSCCH+PSSCH transmitted through the respective beams. This will be described in more detail with reference to the examples below. In the examples below, for convenience of description, it will be described assuming the case where the PSCCH+PSSCH is transmitted.

For example, it is assumed that the TX-UE attempts to transmit the PSCCH+PSSCH through 10 beams. In this case, the TX-UE may reserve and operate 10 PSFCH resources for the PSCCH+PSSCH transmitted through the respective beams. In other words, when attempting to transmit the PSCCH+PSSCH through 10 beams, a common PSFCH resource for the PSCCH+PSSCH transmitted 10 times through the respective beams may be reserved and operated.

As another example, one PSFCH resource may be reserved and operated. In other words, when one PSFCH resource can be transmitted through a specific number of beams, the TX-UE may configure and operate a common PSFCH resource for multiple PSCCH+PSSCHs.

This will be described with a specific example. A case where one PSFCH resource is configured and operated as a feedback resource for the PSCCH+PSSCH transmitted through two beams may be assumed. If one PSFCH resource is configured and operated as a feedback resource for the PSCCH+PSSCH transmitted through two beams, in an environment where transmission of the PSCCH+PSSCH is attempted through 10 beams, a total of 5 PSFCH resources may be reserved and operated.

As another specific example, a case where one PSFCH resource is configured and operated as a feedback resource for the PSCCH+PSSCH transmitted through 5 beams. If one PSFCH resource is configured and operated as a feedback resource for the PSCCH+PSSCH transmitted through 5 beams, in an environment where transmission of the PSCCH+PSSCH is attempted through 10 beams, a total of 2 PSFCH resources may be reserved and operated.

In the exemplary embodiments described above, if one PSCCH+PSSCH transmission is possible per slot, one PSFCH resource may need to be reserved for every two slots or every five slots. In other words, a PSFCH resource periodicity may be X slots, and a value of X may be set and operated by cell-specific or RP-specific higher layer signaling such as MAC-CE, RRC, S-SIB, or S-MIB.

In these PSFCH resource reservation/configuration methods, the TX-UE may transmit PSFCH resource information to the RX-UE through the PSCCH and/or higher layer signaling. Accordingly, the RX-UE may obtain the PSFCH resource information through the received PSCCH and/or higher layer signaling. Further, the RX-UE may obtain beam pairing information received through the same beam. Accordingly, the RX-UE may transmit a response to the received beam pairing information (e.g. indication for the received beam) to the TX-UE based on the PSFCH resource information.

Therefore, the TX-UE may perform beam pairing for SL communication with the RX-UE based on the beam indication information received from the RX-UE and the beam transmitted by the RX-UE. In other words, the TX-UE may determine a transmission beam to be transmitted to the RX-UE and an reception beam for the RX-UE. Once the transmission beam and reception beam are determined through the beam pairing, the TX-UE and the RX-UE may perform SL communication using the paired beams.

In the example of FIG. 9, when one PSFCH resource for the PSCCH+PSSCH transmitted through three beams is allocated and operated, the RX-UE may transmit an indicator configured for each beam as shown in Table 3 below to indicate a specific beam index.

TABLE 3

| Beam index | Beam indication |
|---|---|
| First beam (Beam #1) | 00 or sequence #1 |
| Second beam (Beam #2) | 01 or sequence #2 |
| Third beam (Beam #3) | 10 or sequence #3 |

As exemplified in Table 3 above, a specific bit indicator may be used to identify each beam index. As another example, as exemplified in Table 3, the TX-UE may map a sequence indicator to identify each beam index. Accordingly, the RX-UE that receives a beam through which the PSCCH+PSSCH transmitted by the TX-UE is received may feed back to the TX-UE whether the PSCCH+PSSCH has been successfully received through a PSFCH resource associated with an indicator corresponding to a beam index of the received beam.

If the PSCCH+PSSCH is received through multiple beams, the RX-UE may select an indicator corresponding to a beam index of a beam with a good quality when receiving the PSCCH+PSSCH, and feedback whether the PSCCH+PSSCH has been successfully received through a PSFCH resource associated with the indicator. The quality of the PSCCH+PSSCH signal may be measured using a value such as reference signal received power (RSRP) measured for a signal of each channel or a reference signal of each channel. In all exemplary embodiments of the present disclosure described below, the quality of the PSCCH+PSSCH may be measured using a value measured for a signal of each channel or a reference signal of each channel.

In another exemplary embodiment of the present disclosure, after beam sweeping-based PSCCH+PSSCH transmission, the RX-UE may need to transmit indication information for the beam and ACK/NACK information for data transmitted through the PSSCH. The indication information for the beam and the ACK/NACK information for data transmitted through the PSSCH may be multiplexed and transmitted in a form as shown in Table 4 below.

TABLE 4

| Beam index and ACK/NACK | Indication |
|---|---|
| First beam (Beam #1), ACK | 000 or sequence #1 |
| First beam (Beam #1), NACK | 001 or sequence #2 |
| Second beam (Beam #2), ACK | 010 or sequence #3 |
| Second beam (Beam #2), NACK | 011 or sequence #4 |
| Third beam (Beam #3), ACK | 100 or sequence #5 |
| Third beam (Beam #3), NACK | 101 or sequence #6 |

In Table 4, for example, if the PSCCH+PSSCH that has been successfully received is transmitted through the second beam (i.e. Beam #2), and decoding of the PSSCH is successful, the RX-UE may simultaneously transmit information on the beam index and whether the PSSCH has been successfully received to the TX-UE by transmitting ‘010’ or ‘sequence #3’ through the PSFCH.

When the TX-UE and the RX-UE operate based on Table 3, the RX-UE and the TX-UE may operate based on the following interpretation. The RX-UE may transmit the beam indication information through the corresponding beam only when the received PSSCH has been successfully decoded. For example, if the PSSCH received through the second beam (i.e. Beam #2) has been successfully decoded, the beam indication ‘01’ or sequence #2 may be transmitted to the TX-UE. The TX-UE, which receives the beam indication ‘01’ or sequence #2 from the RX-UE, may determine that the PSSCH transmitted through the second beam (Beam #2) is acknowledged (ACKed) and that NACKs are transmitted for the remaining other beams (i.e. Beam #1, Beam #3).

The examples of Table 3 and Table 4 described above may correspond to the case where the TX-UE transmits the PSCCH+PSSCH by beam sweeping using three different beams as illustrated in FIG. 9. Therefore, Table 3 and Table 4 may be extended based on the contents described above when more beams are used.

The examples of Table 3 and Table 4 describe the case where the RX-UE transmits an indicator for one beam index. However, the RX-UE may transmit an indicator for multiple beams. Table 5 below is a mapping example for indication information for multiple beams.

TABLE 5

| Indication | Relative resource position of beam |
|---|---|
| 00 or sequence #1 | First beam sweeping transmission resource |
| 01 or sequence #2 | Second beam sweeping transmission resource |
| 10 or sequence #3 | Third beam sweeping transmission resource |
| 11 or sequence #4 | Fourth beam sweeping transmission resource |

As exemplified in Table 5, an indicator for each beam or a combination of multiple beams may be allocated and operated in form of bits or a sequence. Table 5 may be extended to include ACK/NACK indication information corresponding to the PSSCH in the form of Table 4 described above. In other words, when transmitting information on relative positions of beams and ACK/NACK indication information by multiplexing them, the number of bits or the number of sequences may be extended to transmit the ACK/NACK indication information corresponding to the PSSCH together.

In the example of Table 5, the beam index may be an absolute index value for the beam. For example, if the total number of beams used for beam sweeping is limited to 64, the index for each beam may be expressed with 6-bit information.

As another method, it may be an index value determined by a relative position of the PSCCH+PSSCH resource by each beam. For example, indication information for the beam transmitted through the PSFCH resource 940 in FIG. 9 may be information indicating the relative position of the PSCCH+PSSCH resource transmitted by each beam before the PSFCH resource. In this case, the beam indication information may not indicate a specific beam, but indicate a position of a specific resource. For example, if 4 beams are transmitted by beam sweeping before the beam indication through the PSFCH, the relative resource position for each beam sweeping may be indicated using 2 bits as exemplified in Table 5. In other words, when ‘01’ is indicated through the PSFCH, a transmission beam (TX-beam) transmitted in the second beam sweeping transmission resource may be indicated.

The indication method exemplified in Table 5 will be described below.

The TX-UE may transmit a PSCCH+PSSCH through a specific beam in a specific resource. Therefore, the TX-UE may obtain information on a position of a resource where the PSCCH+PSSCH is transmitted from the indication information transmitted by the RX-UE. When the TX-UE identifies the position of the resource where the PSCCH+PSSCH is transmitted, the TX-UE may obtain information on the beam through which the PSCCH+PSSCH is transmitted. Therefore, when the TX-UE transmits the PSCCH+PSSCH through a specific resource by beam sweeping, it needs to store information on the resource information and information on the beam transmitted in the corresponding resource.

In the present disclosure described below, the beam index may be absolute index information for the beam, as described with reference to Table 5, or may be information indicating the relative position of the resource.

When transmitting the PSCCH+PSSCH through three beams as illustrated in FIG. 9, PSFCH resources corresponding to the number of beams may be allocated and operated in an one-to-one manner. When PSFCH resources corresponding to the number of beams used for transmitting the PSCCH+PSSCH are allocated and operated in the one-to-one manner, the RX-UE may measure a quality of each received PSCCH+PSSCH. Then, the RX-UE may transmit an indicator indicating the corresponding beam through each of PSFCH resources corresponding to one or more beam indexes having good quality based on reception qualities measured by the RX-UE. In this case, the position of the resource selected by the RX-UE already includes the indication information for the specific beam. Therefore, unlike Table 3 described above, the RX-UE may perform transmission of signals in form on which the TX-UE can perform energy detection. In this case, the TX-UE may operate to determine a reception error of the received beam index information by comparing the position of the PSFCH resource and the beam indication information received through the corresponding PSFCH. If the TX-UE determines that the received beam index information has an error according to a result of comparing the position of the PSFCH resource and the beam indication information received through the corresponding PSFCH, the TX-UE may continue to perform beam sweeping transmission of the PSCCH+PSSCH.

As shown in FIG. 9, when transmitting the PSCCH+PSSCH through three beams, another operation method in which the same number of PSFCH resources as the number of beams are allocated will be described. Instead of transmitting the beam indication information through the PSFCH resource as in the example of Table 3, a sequence or bit information indicating ACK/NACK may be transmitted through each PSFCH resource as shown in Table 6 below.

TABLE 6

| Positive response (ACK) | Negative response (NACK) |
|---|---|
| 0 or sequence #1 | 1 or sequence #2 |

As shown in Table 6, when the RX-UE transmits the PSFCH to the TX-UE, the RX-UE may transmit the PSFCH in the same manner as Table 6. In the case of Table 6, since the same number of PSFCH resources as the number of beams are allocated and operated as in the previous assumption, selection of a specific PSFCH resource already includes beam indication information. In other words, the selection of the PSFCH resource by the RX-UE means the selection of a specific beam among the beams transmitted by the TX-UE. Therefore, the RX-UE may additionally transmit ACK/NACK information for the reception of the PSCCH+PSSCH transmitted by the TX-UE in the selected PSFCH resource.

According to another method of the present disclosure, one PSFCH resource may be configured to indicate one or more beams as shown in Table 7 below.

TABLE 7

| Beam index | Beam indication |
|---|---|
| First beam (Beam #1) | 000 or sequence #1 |
| Second beam (Beam #2) | 001 or sequence #2 |
| Third beam (Beam #3) | 010 or sequence #3 |
| First beam and second beam (Beam #1, #2) | 011 or sequence #4 |
| Second beam and third beam (Beam #2, #3) | 100 or sequence #5 |
| First beam and third beam (Beam #1, #3) | 101 or sequence #6 |
| First beam, second beam, and third beam | 111 or sequence #7 |
| (Beam #1, #2, #3) | |

The case of Table 7 is an example of a case where the PSCCH+PSSCH is transmitted by beam sweeping using three beams as illustrated in FIG. 9.

As described in FIG. 9, when the PSCCH+PSSCH is transmitted by beam sweeping, the RX-UE may receive the PSCCH+PSSCH without error through one beam or two or more beams. Since the case where the RX-UE receives the PSCCH+PSSCH without error through one beam has been described in the previous exemplary embodiments, the case where the PSCCH+PSSCH is received without error through two beams will be described.

For example, when the RX-UE receives the PSCCH+PSSCH without error through the second beam (Beam #2) and the third beam (Beam #3), the RX-UE may feedback bits of ‘100’ or a sequence #5 to the TX-UE through the PSFCH. As another example, when the RX-UE receives the PSCCH+PSSCH through the first beam (Beam #1), the second beam (Beam #2), and the third beam (Beam #3), and a signal quality of each of the second beam and third beam is equal to or greater than a predetermined threshold, the RX-UE may feedback the bits of ‘100’ or sequence #5 to the TX-UE through the PSFCH.

In either of the two above-described cases, the TX-UE and the RX-UE may perform SL communication using the second beam (Beam #2) and/or the third beam (Beam #3).

Meanwhile, the method of Table 7 may also be applied as being modified into a form in which a relative position of the PSCCH+PSSCH resource transmitted by beam sweeping before the PSFCH transmission time as in Table 5 described above. In other words, when receiving multiple beams without error, a form that indicates the relative positions of multiple PSCCH+PSSCH resources may be applied.

The mapping methods of Tables 3 to 7 described above may be extended or modified in various manners and applied between the TX-UE and RX-UE. However, the mapping information of Tables 3 to 7 needs to be shared between the TX-UE and RX-UE. In order to share the mapping information of Tables 3 to 7 between the TX-UE and RX-UE, the mapping information may be configured by cell-specific or RP-specific higher layer signaling such as MAC-CE, RRC, S-SIB, or S-MIB. The methods of transmitting beam index information or ACK/NACK information through the PSFCH resource may be applied in a simple, modified, combined, and/or extended manner in the exemplary embodiments described below.

Meanwhile, if the TX-UE fails to receive the PSFCH or if there is an error in the beam index information of the received PSFCH, the TX-UE may attempt beam sweeping-based retransmission of the PSCCH+PSSCH with the same beams as illustrated in FIG. 9.

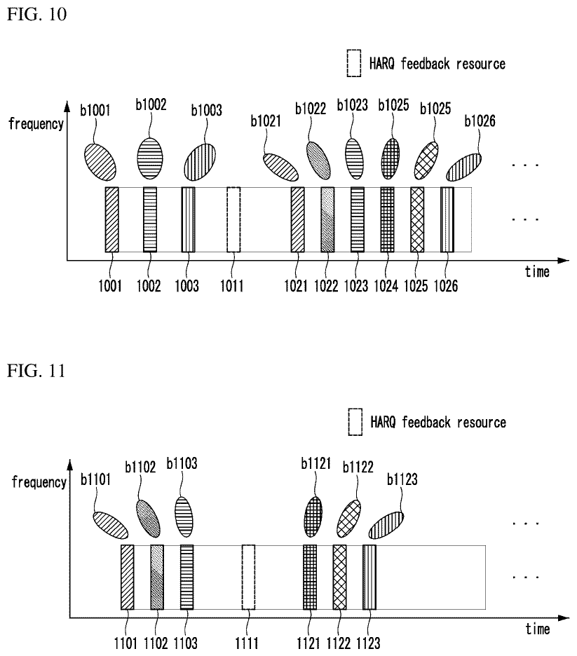

FIG. 10 is a conceptual diagram for describing a case where a TX-UE transmits a PSCCH in a beam sweeping manner within a specific resource region according to another exemplary embodiment of the present disclosure.

As shown in FIG. 10, the horizontal axis represents time resources and the vertical axis represents frequency resources. In addition, a plurality of resources 1001, 1002, 1003, 1011, 1021, 1022, 1023, 1024, 1025, and 1026, each of which is a time and frequency resource, are illustrated.

According to the example of FIG. 10, when a TX-UE initially transmits a PSCCH or PSCCH+PSSCH by beam sweeping, the TX-UE may repeatedly transmit the PSCCH or PSCCH+PSSCH using three beams b1001, b1002, and b1003. In other words, the TX-UE may perform beamforming on the first resource 1001 in a first direction to transmit the PSCCH or PSCCH+PSSCH through the first beam b1001, may perform beamforming on the second resource 1002 in a second direction to transmit the PSCCH or PSCCH+PSSCH through the second beam b1002, and may perform beamforming on the third resource 1003 in a third direction to transmit the PSCCH or PSCCH+PSSCH through the third beam b1003.

The TX-UE may attempt to receive a PSFCH through a HARQ feedback resource 1011. If the TX-UE fails to receive a PSFCH from the RX-UE or if there is an error in beam index information received through a PSFCH from the RX-UE, finer beams may be used.

Referring to FIG. 10, if the TX-UE fails to receive a PSFCH from the RX-UE after attempting to receive a PSFCH or if there is an error in beam index information received through a PSFCH from the RX-UE, the TX-UE may attempt to retransmit the PSCCH or PSCCH+PSSCH through finer beams b1021 to b1026 in the 6 time-frequency resources 1021 to 1026 after the PSFCH resource 1011. In this case, as illustrated in FIG. 10, a beam width of initial transmission beams of the PSCCH or PSCCH+PSSCH may be wider than to that of the beams used for retransmission, and the beams used for transmitting the PSCCH or PSCCH+PSSCH at the time of retransmission may have a narrower beam with than that of the beams used for the initial transmission.

In other words, although the TX-UE transmits all beams during one period by transmitting the PSCCH or PSCCH+PSSCH in the beam sweeping manner, if there is no feedback or an error in a feedback through the PSFCH, the TX-UE may perform beam sweeping using more beams than the beams of the first beam sweeping period in the second beam sweeping period. In this case, the TX-UE may transmit the PSCCH or PSCCH+PSSCH using finer beams in the second beam sweeping period, for example, beams with a narrower bandwidth, than the beams of the first beam sweeping period.

FIG. 11 is a conceptual diagram illustrating a case where a TX-UE transmits a PSCCH or PSCCH+PSSCH in a beam sweeping manner within a specific resource region according to yet another exemplary embodiment of the present disclosure.

As shown FIG. 11, the horizontal axis represents time resources, and the vertical axis represents frequency resources. In addition, a plurality of resources 1101, 1102, 1103, 1111, 1121, 1122, and 1123, each of which is a time and frequency resource, are illustrated.

As illustrated in FIG. 11, according to the present disclosure, when the TX-UE transmits a PSCCH or PSCCH+PSSCH in a beam sweeping manner, the TX-UE may transmit the PSCCH or PSCCH+PSSCH using 6 beams b1101, b1102, b1103, b1121, b1122, and b1123.

The example of FIG. 11 may correspond to a case where the number of beams used by the TX-UE for PSCCH or PSCCH+PSSCH transmission is large, or there is a constraint on the resources allocated for beam sweeping transmission. In this case, the TX-UE may divide the entire beams b1101 to b1103 and b1121 to b1123 into a specific number of groups as illustrated in FIG. 11, and transmit the PSCCH or PSCCH+PSSCH within multiple time resource regions in a beam sweeping manner. The example of FIG. 11 may correspond to a case where transmission is performed by dividing the beams into groups each having three beams.

Accordingly, the TX-UE may transmit the PSCCH or PSCCH+PSSCH using three beams b1101 to b1103 in three time resource regions 1101, 1102, and 1103, and wait for reception of a PSFCH through a HARQ feedback resource 1111. Then, the TX-UE may transmit the PSCCH or PSCCH+PSSCH using three beams b1121 to b1123 in three time resource regions 1121, 1122, and 1123.

In the exemplary embodiment of FIG. 11, the case of dividing 6 beams into groups each having three beams and transmitting the PSCCH or PSCCH+PSSCH using the two groups is exemplified. However, it should be noted that the present disclosure is not limited to the case illustrated in FIG. 11 in terms of the number of beams and the number of times of transmitting the divided beams. In other words, if the TX-UE uses X or more beams, the exemplary embodiment may be modified to a form of dividing them into two or more groups and transmitting the divided beams.

For example, the TX-UE may divide 12 beams into 2 groups and transmit them. The form of transmitting 6 beams once may correspond to the scheme described in the retransmission process of the PSCCH or PSCCH+PSSCH in FIG. 10 described above. As another example, 12 beams may be divided into 3 groups each having 4 beams, and the PSCCH or PSCCH+PSSCH may be transmitted through 3 beam sweeping operations each using 4 beams. As another example, 12 beams may be divided into 4 groups each having 3 beams, and the PSCCH or PSCCH+PSSCH may be transmitted through 4 beam sweeping operations each using 3 beams.

As described above, the consecutive time resources configured for transmitting the PSCCH or PSCCH+PSSCH in the beam sweeping manner are referred to as ‘beam sweeping resource’.

In other words, a case where the total number of beams operated by the TX-UE is 12, and one beam sweeping resource has 6 consecutive time resources may be assumed. In this case, one beam sweeping resource may be configured with 6 consecutive time resources. Therefore, in the above-described assumption, the TX-UE may transmit the PSCCH or PSCCH+PSSCH using two beam sweeping resources for the entire beams. Here, one time resource among the consecutive time resources may refer to a time resource region for transmitting the PSCCH or PSCCH+PSSCH through one specific beam. Alternatively, one beam sweeping resource may be configured as a resource corresponding to one beam for transmitting the PSCCH or PSCCH+PSSCH.

In the example of FIG. 11, it is assumed that the TX-UE operates a total of 6 beams for transmission of the PSCCH or PSCCH+PSSCH. The TX UE may use 3 beams b1101 to b1103 to transmit the PSCCH or PSCCH+PSSCH in the beam sweeping manner. Thereafter, the TX-UE may receive beam indication information from the RX-UE through a PSCFCH resource 1111. If the TX-UE receives the beam indication information through the PSFCH, the TX-UE may stop beam sweeping transmission.

As another example, even if the TX-UE receives beam indication information from the RX-UE after transmitting the PSCCH or PSCCH+PSSCH in the beam sweeping manner using the 3 beams b1101 to b1103, the TX-UE may continue to transmit the remaining 3 beams b1121 to b1123. Thereafter, the TX-UE may obtain additional beam indication information through a PSFCH. If the TX-UE receives beam indication information from the RX-UE after using the 3 beams b1101 to b1103 to transmit the PSCCH or PSCCH+PSSCH, and then obtains additional beam indication information through a PSFCH after using the remaining 3 beams b1121 to b1123 to transmit the PSCCH or PSCCH+PSSCH, the TX-UE may communicate with the RX-UE using a preferred beam, a beam with better reception quality, or an arbitrary beam among beams indicated by the beam indication information.

Meanwhile, the TX-UE may set the number of consecutive time resources available for beam sweeping transmission and configure the corresponding time resource regions that occur periodically thereafter. For this operation, the TX-UE may generate configuration information of the number of consecutive time resources and the corresponding time resource regions that occur periodically, as shown in Table 8 below.

TABLE 8

| | The number of | Beam sweeping resource repetition |
|---|---|---|
| | consecutive time | periodicity/The number of |
| | resources within one | configured beam sweeping |
| Indicator | beam sweeping resource | resources |
| 00 | 2 | X1 ms/Y1 |
| 01 | 4 | X2 ms/Y2 |
| 10 | 8 | X3 ms/Y3 |
| 11 | 12 | X4 ms/Y4 |

Table 8 shows an example of beam sweeping resource configuration. Describing information shown in Table 8, the number of consecutive time resources within one beam sweeping resource may be the same number of resources as 3 consecutive time resources 910, 920, and 930, as described above in FIG. 9. Table 8 shows cases where 2, 4, 8, and 12 consecutive time resources are configured.

In addition, a beam sweeping resource repetition periodicity may correspond to a periodicity for transmitting the PSCCH and PSSCH in the beam sweeping manner. For example, the beam sweeping resource repetition periodicity may have various periodicity values, such as 5 ms, 10 ms, and 20 ms. In addition, the number of configured beam sweeping resources may refer to how beam sweeping resources are included in one beam sweeping resource repetition period.

The resource configuration information and indicators exemplified in Table 8 may be configured and used by cell-specific or RP-specific higher layer signaling such as MAC-CE, RRC, S-SIB, and S-MIB.

Then, a case where the TX-UE performs beam sweeping through the indicator value of Table 8 after the TX-UE transmits the configuration information of Table 8 will be described.

For example, if the TX-UE sets the indicator to ‘01’, the number of consecutive time resources in one beam sweeping resource may be 4. Therefore, if the indicator is indicated as ‘01’, the TX-UE may transmit the PSCCH and PSSCH using 4 consecutive beams in the beam sweeping manner. If the indicator is indicated as ‘01’, the beam sweeping may occur Y2 times at a periodicity of X2 [ms]. When Y2 is set to 1, one beam sweeping resource may be included during X2 ms. Therefore, if the indicator is indicated as ‘01’, the TX-UE may transmit the PSCCH or PSCCH+PSSCH using 4 beams through 4 consecutive time resources that exist once within the period of X2 ms. In this case, the 4 beams used by the TX-UE may be the same beam or different beams. On the other hand, only the configuration information for the periodicity in Table 8 may be indicated and the number of beam sweeping resources may not be set. Table 8 is merely an example for configuration of beam-sweeping resources according to the present disclosure, and may be applied in various forms by being modified and extended based on the contents of Table 8.

Meanwhile, in the examples of FIG. 10 and FIG. 11 described above, the mapping schemes of Table 3, Table 6, and Table 7 may be operated in various forms by being extended and modified. In addition, the information of each table may be configured by cell-specific or RP-specific higher layer signaling such as MAC-CE, RRC, S-SIB, and S-MIB. The schemes of transmitting beam index information and/or ACK/NACK information through the PSFCH resource may be applied to exemplary embodiments described below in a simple, modified, combined, and extended manner.

According to the exemplary embodiments described above, when the TX-UE transmits the PSCCH+PSSCH in the beam sweeping manner, the TX-UE may receive a feedback on a specific beam from the RX-UE, and if there is no error in beam indication information, the TX-UE may stop the beam sweeping transmission of the PSCCH+PSSCH. Then, the TX-UE may perform sidelink communication with the RX-UE that fed back the specific beam through the corresponding transmission beam (TX-beam).

### [Beam Sweeping-Based PSCCH+PSSCH Transmission Resource Allocation Method]

When the sidelink-primary synchronization signal (S-PSS), sidelink-secondary synchronization signal (S-SSS), and physical sidelink broadcast channel (PSBCH) are transmitted based on the S-SSB structure, periodicity (160 ms), and the number of S-SSBs that can be transmitted within one period, which are defined in the current 3GPP NR standards, a transmission entity of S-SSB (e.g. TX-UE) may transmit the signals in a beam sweeping manner in a high-frequency band including FR2.

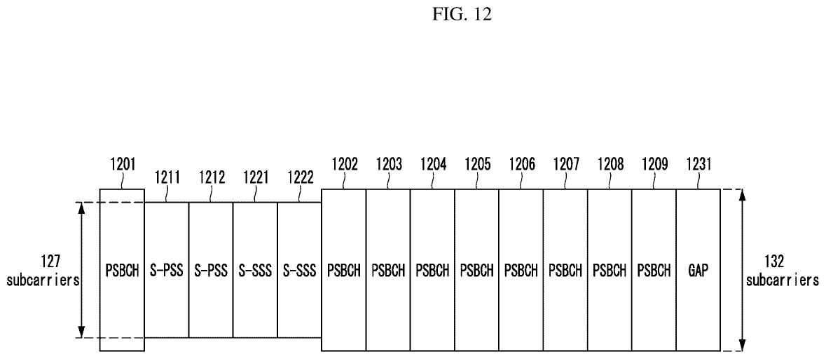

FIG. 12 is a diagram illustrating a structure of an S-SSB with a normal CP according to the 3GPP NR standards.

The S-SSB illustrated in FIG. 12 corresponds to an S-SSB with a normal cyclic prefix (CP). In FIG. 12, the horizontal axis corresponds to a time axis and the vertical axis corresponds to a frequency axis. In the NR system, a subcarrier spacing (SCS) varies depending on a numerology, and a structure of a normal CP or extended CP may be used based on a delay spread. One slot constituting the S-SSB with a normal CP may be composed of 14 OFDM symbols, as illustrated in FIG. 12.

As shown in FIG. 12, a PSBCH is transmitted in the first symbol 1201 in the time domain, a S-PSS is transmitted in the second symbol 1212 and the third symbol 1213, and a S-SSS is transmitted in the fourth symbol 1221 and the fifth symbol 1222. Thereafter, the PSBCH is transmitted in eight symbols 1202 to 1209. The last symbol 1231 is a gap symbol, commonly called a guard symbol, in which no signal is transmitted.

Meanwhile, in the case of the extended CP, which is not illustrated in FIG. 12 but in which one slot consists of 12 OFDM symbols, an S-SSB may be composed of 2 S-PSS symbols, 2 S-SSS symbols, and 7 PSBCH symbols. That is, the slot for the extended CP has 2 less PSBCH symbols than the slot for the normal CP. In addition, no signal is transmitted in the last symbol of the slot in both the normal CP case and the extended CP case.

In addition, as illustrated in FIG. 12, the PSBCH symbols 1201 and 1202 to 1209 are configured with 132 subcarriers, and the S-PSSs symbols 1211 and 1212 and the S-SSSs symbols 621 and 622 are configured with 127 subcarriers. Therefore, it can be seen that the S-SSB is transmitted through 11 resource blocks (RBs) within a sidelink bandwidth part (SL BWP).

Meanwhile, when the S-PSS, S-SSS, and PSBCH are transmitted based on the S-SSB structure, periodicity (160 ms), and the number of S-SSBs that can be transmitted within one period, which are defined in the current 3GPP NR standards, a transmission entity of S-SSB (e.g. TX-UE) may transmit the signals in a beam sweeping manner in a high-frequency band including FR2.

As described above, a synchronization signal TX-UE that transmits S-SSBs by performing beam sweeping using multiple beams in a high-frequency band may transmit the S-SSBs having the structure illustrated in FIG. 12 for each beam at a periodicity of 160 ms, which is an S-SSB transmission periodicity. For example, if the S-SSB is configured to be transmitted 8 times at a periodicity of 160 ms, the transmitting entity (e.g. TX-UE) may transmit the S-SSB 8 times using available beams within the S-SSB period. In this case, if the total number of beams available to the transmitting entity (e.g. TX-UE) is 4, each S-SSB may be repeatedly transmitted twice with 4 different beams.

In the present disclosure, PSCCH+PSSCH transmission may be performed in a time interval in which S-SSB transmission is performed for beam sweeping-based PSCCH+PSSCH transmission. For example, the TX-UE may transmit the S-SSB using specific beams in the S-SSB interval. Therefore, the TX-UE may transmit the PSCCH+PSSCH using the same beams as the beams used for S-SSB transmission, that is, the beams for transmitting the S-SSBs through beam sweeping. In addition, when the TX-UE transmits the S-SSBs, the TX-UE may transmit the PSCCH+PSSCH through a frequency resource different from the frequency resource in which the S-SSB is transmitted in the same time resource region in which the S-SSB is transmitted.

The examples described above and their modified examples will be described with reference to the attached drawings.

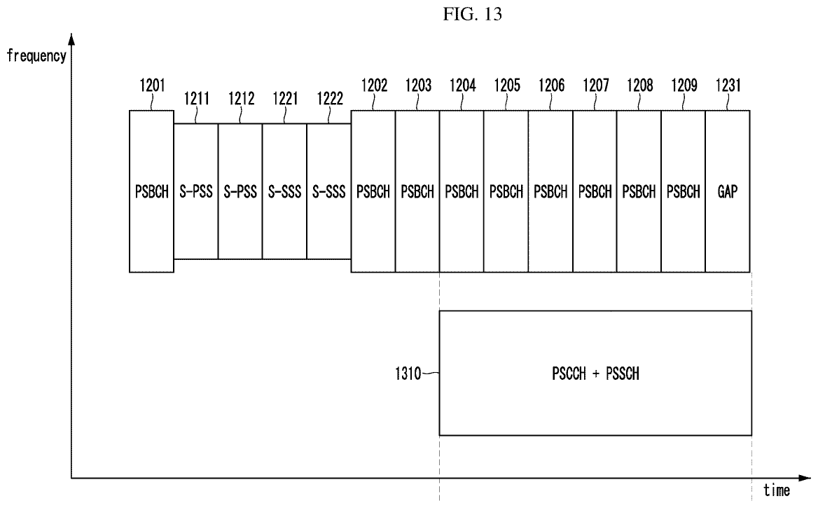

FIG. 13 is a conceptual diagram for describing a case where a TX-UE transmits a PSCCH+PSSCH using a part of a time interval for S-SSB transmission according to an exemplary embodiment of the present disclosure.

In FIG. 13, the horizontal axis represents time resources and the vertical axis represents frequency resources. Since a transmission operation of FIG. 13 is performed by a TX-UE, the following description will assume a case where the TX-UE is allocated resources and perform transmission as in FIG. 13.

In the exemplary embodiments described below, there may be two cases as a method for the TX-UE to be allocated resources.

First, a base station may allocate resources to be used by a specific UE or all UEs and inform each UE or all UEs of information on the allocated resources. Accordingly, each UE may transmit a signal based on the information on the resources allocated by the base station.

Second, the TX-UE may select and reserve resources that do not collide with other transmitting nodes from a transmission resource pool through a scheme such as resource sensing without intervention of the base station, and transmit a signal using the resources.

The resources described above may become beam sweeping resources according to the present disclosure.

The TX-UE may be allocated a frequency resource for PSCCH+PSSCH transmission among frequency resources different from a frequency resource for S-SSB transmission. In addition, the TX-UE may determine a time resource for PSCCH+PSSCH transmission to overlap with a part of a time resource for S-SSB transmission. Specifically, the TX-UE may be configured not to transmit a PSCCH+PSSCH 1310 in time resources for transmitting the PSBCH symbol 1201, S-PSS symbols 1211 and 1212, S-SSS symbols 1221 and 1222, and PSBCH symbols 1202 and 1203. The TX-UE may transmit the PSCCH+PSSCH 1310 using a frequency resource different from a frequency resource for S-SSB transmission in time resources for the PSBCH symbols 1204 to 1209 and GAP symbol 1231. In this case, the TX-UE may transmit the PSCCH+PSSCH 1310 or may transmit only the PSCCH.

In addition, the TX-UE may transmit all signals illustrated in FIG. 13 using the same beam. For example, when the TX-UE performs beamforming on each of the PSBCH symbols 1201 to 1209 using a specific beam, the TX-UE may transmit the PSCCH+PSSCH 1310 by using the same beam as the specific beam used for the corresponding PSBCH symbols.

Meanwhile, when the TX-UE wishes to transmit the PSCCH+PSSCH 1310 in the same time region as the S-SSB, the TX-UE may determine which time resources of the S-SSB to transmit the PSCCH+PSSCH 1310 by considering a position of a slot where the PSCCH+PSSCH 1310 can be transmitted or a position of symbol(s) where the PSCCH+PSSCH 1310 can be transmitted within the slot. According to the example of FIG. 13, the TX-UE may transmit the PSCCH+PSSCH 1310 using the eighth to fourteenth symbols of the slot in which S-SSB is transmitted.

The TX-UE may determine resources, for example, specific time and frequency resources, to transmit the PSCCH+PSSCH 1310 based on resources for S-SSB transmission. For example, when the TX-UE according to the present disclosure determines time resources to transmit the PSCCH+PSSCH 1310 based on time resource regions for S-SSB transmission, the TX-UE may allocate time resources corresponding to the remaining symbols excluding the symbols for transmission of the synchronization signals 1211, 1212, 1221, and 1222 among the S-SSB symbols, so as not to cause interference with detection of synchronization signal sequences.

If the TX-UE does not perform S-SSB transmission, the PSCCH+PSSCH 1310 may be transmitted using all or part of the S-SSB transmission resource region. This will be described with reference to the drawings below.

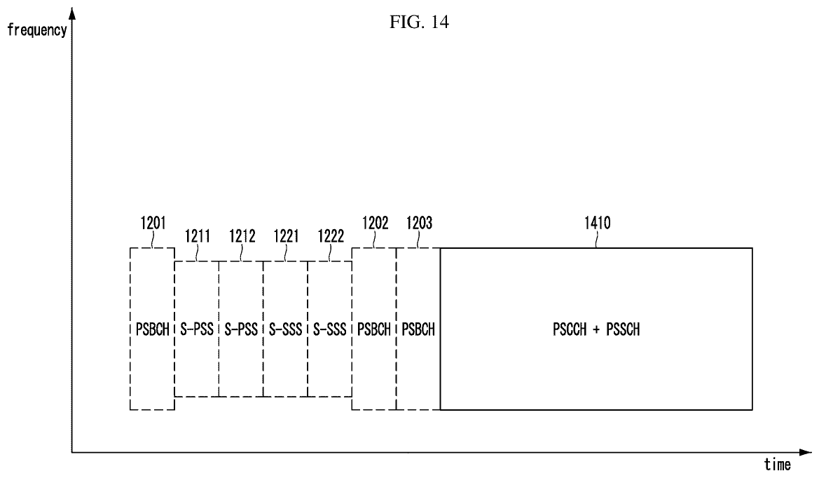

FIG. 14 is a conceptual diagram for describing a case where a TX-UE that does not transmit S-SSB transmits a PSCCH+PSSCH according to an exemplary embodiment of the present disclosure.

In FIG. 14, the horizontal axis represents time resources and the vertical axis represents frequency resources. As shown in FIG. 14, a TX-UE that does not transmit S-SSB may transmit a PSCCH+PSSCH 1410 by using a part of a specific PSBCH resource transmission region within a frequency and time interval of a resource region for S-SSB transmission. In FIG. 14, the PSBCH symbols 1201, 1202, and 1203, S-PSS symbols 1211 and 1212, and P-SSS symbols 1221 and 1222, which are indicated by dotted lines, may not be transmitted by the TX-UE. Also, a reason why the part of the S-SSB is indicated by dotted lines is to enable identification that the PSCCH+PSSCH 1410 is transmitted utilizing at least part of the resource of S-SSB.

The case where the TX-UE that does not transmit S-SSB may correspond to a case where the TX-UE is not a synchronization reference node. Therefore, a synchronization reference node may exist in an adjacent area. Here, the synchronization reference node may be a communication node that transmits S-SSBs. The synchronization reference node may be a specific TX-UE or a base station.

In the case where the TX-UE does not transmit S-SSBs, another communication node (i.e. synchronization reference node) in an adjacent area of the TX-UE may transmit S-SSBs. In addition, the TX-UE that does not transmit S-SSBs may know information on resources configured for the synchronization reference node to transmit S-SSBs. Therefore, the TX-UE that does not transmit S-SSBs may operate the transmission of PSCCH+PSSCH 1410 to minimize the influence of interference caused by signals transmitted by the TX-UE on other UEs receiving the S-SSB transmission resources.

For example, as illustrated in FIG. 14, resources for the PSCCH+PSSCH 1410 may be configured so as not to overlap with S-PSS symbols 1211 and 1212 and S-SSS symbols 1221 and 1222, which are synchronization signals in the S-SSB transmitted by the synchronization reference node. The example of FIG. 14 may correspond to a case where the TX-UE transmits the PSCCH+PSSCH 1410 using the eighth to fourteenth symbols among the S-SSB symbols.

When transmitting the PSCCH+PSSCH 1410 as illustrated in FIG. 14, the TX-UE may transmit the PSCCH+PSSCH 1410 using beams corresponding to a beam sweeping order configured for S-SSB transmission. As another example, when transmitting the PSCCH+PSSCH 1410 as illustrated in FIG. 14, the TX-UE may configure a beam set for transmitting the PSCCH+PSSCH 1410 and transmit the PSCCH+PSSCH 1410 using beams of the configured beam set.

In the above description, the transmission of the PSCCH+PSSCH 1410 as illustrated in FIG. 14 may mean transmitting the PSCCH+PSSCH 1410 in a specific resource region within a resource region for PSBCH transmission excluding a resource region for S-PSS and S-SSS transmission, in order not to cause interference with transmission and reception of synchronization signals of other communication nodes.

As described above in FIG. 13 and/or FIG. 14, when allocating PSCCH+PSSCH transmission resources and transmitting the PSCCH+PSSCH, transmission of the PSCCH+PSSCH may be attempted in the same manner as the method of transmitting S-SSB by beam sweeping. Then, methods of transmitting the PSCCH+PSSCH by beam sweeping will be described below.

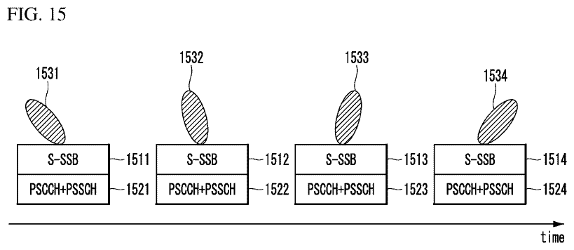

FIG. 15 is a conceptual diagram for describing a case of transmitting a PSCCH+PSSCH by beam sweeping in the same manner as S-SSB beam sweeping according to an exemplary embodiment of the present disclosure.

As shown in FIG. 15, 4 different beams 1531, 1532, 1533, and 1534 are illustrated. The 4 different beams 1531 to 1534 may be beams for transmitting S-SSBs 1511, 1512, 1513, and 1514. PSCCH+PSSCHs 1521, 1522, 1523, and 1524 respectively corresponding to the S-SSBs 1511 to 1514 may be transmitted using the same time resources and the same beams 1531 to 1534 as the corresponding S-SSBs 1511 to 1514. In other words, when the TX-UE transmits the PSCCH+PSSCHs 1521 to 1524, the TX-UE may transmit the PSCCH+PSSCHs 1521 to 1524 using the same time resources and the same beams 1531 to 1534 as the time resources and the beams used for transmitting the S-SSBs 1511 to 1514 respectively corresponding to the PSCCH+PSSCHs 1521 to 1524.

Meanwhile, as previously described in FIGS. 13 and 14, resource allocation information for PSCCH+PSSCH transmission and configuration information for beam sweeping transmission of S-SSB and PSCCH+PSSCH may be configured and used by cell-specific or RP-specific higher layer signaling such as MAC-CE, RRC, S-SIB, and S-MIB.

In addition, the structure of S-SSB may be designed by modifying and extending the structure of FIG. 12. Even if the structure of S-SSB is designed by modifying and extending the structure of FIG. 12, the methods described in FIGS. 13 to 15 above may be applied in a simple, modified, combined, and/or extended manner.

Meanwhile, when allocating PSCCH+PSSCH resources as illustrated in FIG. 13 and/or FIG. 14 described above, one TX-UE may transmit multiple PSCCH+PSSCHs. In order for one TX-UE to transmit multiple PSCCH+PSSCHs, resources for transmitting the multiple PSCCH+PSSCHs need to be separately configured. For example, it may be assumed that one TX-UE transmits a first PSCCH+PSSCH and a second PSCCH+PSSCH. In this case, the one TX-UE needs to configure a resource for transmitting the first PSCCH+PSSCH and a resource for transmitting the second PSCCH+PSSCH, respectively. Here, configuration of the resources may mean either allocating resources from a base station or allocating resources in advance through reservation, as described above. The one TX-UE that has configured resources as described above may multiplex and transmit the first PSCCH+PSSCH and the second PSCCH+PSSCH using the configured resources.

Meanwhile, when multiple TX-UEs transmit PSCCH+PSSCHs, respectively, resources may be allocated and operated to avoid collision and interference between the PSCCH+PSSCHs transmitted by the TX-UEs.

Hereinafter, the contents briefly described above will be described in more detail with reference to the attached drawings.

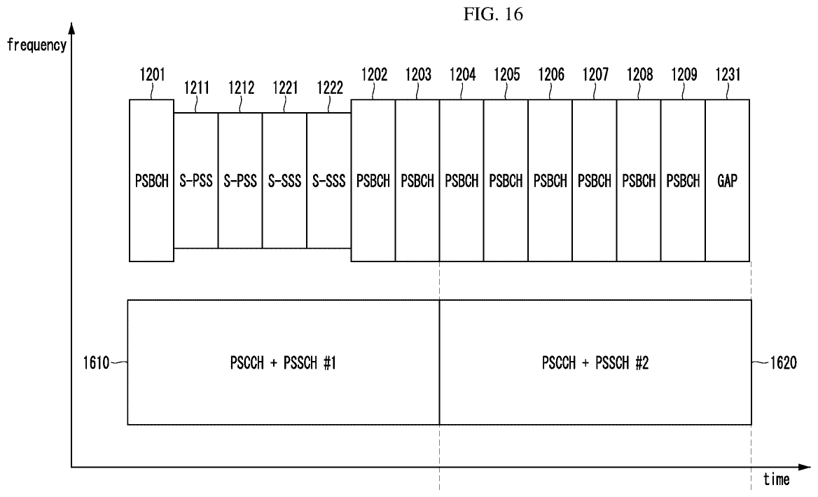

FIG. 16 is a conceptual diagram for describing a case where one TX-UE transmits two different PSCCH+PSSCHs according to an exemplary embodiment of the present disclosure.

In FIG. 16, the horizontal axis represents time resources, and the vertical axis represents frequency resources. Since a transmission operation of FIG. 16 is performed by a TX-UE, the following description will assume that the TX-UE is allocated resources and perform transmission as in FIG. 16.

As shown in FIG. 16, a frequency resource of a PSCCH+PSSCH #1 1610 and a PSCCH+PSSCH #2 1620 transmitted by the TX-UE may allocated as a frequency resource different from frequency resources for transmission of S-SSB symbols. In addition, the frequency resource for transmitting the PSCCH+PSSCH 1610 and the frequency resource for transmitting the PSCCH+PSSCH #2 1620 may the same frequency resource. When the TX-UE according to the present disclosure wishes to transmit the PSCCH+PSSCH 1610 and the PSCCH+PSSCH 1620, the TX-UE may use a frequency resource different from the frequency resource through which S-SSB symbols are transmitted.

As an example modified from FIG. 16, the TX-UE may perform transmission by configuring the frequency resource for the PSCCH+PSSCH #1 1610 and the frequency resource for the PSCCH+PSSCH #2 1620 differently. For example, a frequency resource for transmitting S-SSB may be assumed as a first frequency resource, a frequency resource for transmitting the PSCCH+PSSCH 1610 by the TX-UE may be assumed as a second frequency resource, and a frequency resource for transmitting the PSCCH+PSSCH 1620 by the TX-UE may be assumed as a third frequency resource. In this case, the first frequency resource, the second frequency resource, and the third frequency resource may all be different frequency resources.

In the exemplary embodiment illustrated in FIG. 16, under the above assumption, the second frequency resource and the third frequency resource may be the same frequency resource, and the second frequency resource and the first frequency resource may be different frequency resources.

In addition, in the exemplary embodiment of FIG. 16, time resources for the TX-UE to transmit the PSCCH+PSSCH 1610 and the PSCCH+PSSCH 1620 may correspond to a part of time resources in which S-SSB symbols are transmitted.

Specifically, a time resource for transmitting the PSCCH+PSSCH 1610 may be the same time interval as a time interval in which the first symbol to the seventh symbol of S-SSB is transmitted, and a time resource for transmitting the PSCCH+PSSCH 1620 may be the same time interval as a time interval from the eighth symbol of S-SSB to the last symbol (i.e. GAP symbol) 1231.

For the operation as illustrated in FIG. 16, the TX-UE may operate based on a specific identifier (ID) associated with each of the PSCCH+PSSCHs 1610 and 1620 transmitted by the TX-UE and the size of the time-frequency resource allocated for transmission of one PSCCH+PSSCH among the PSCCH+PSSCH 1610 and the PSCCH+PSSCH 1620.

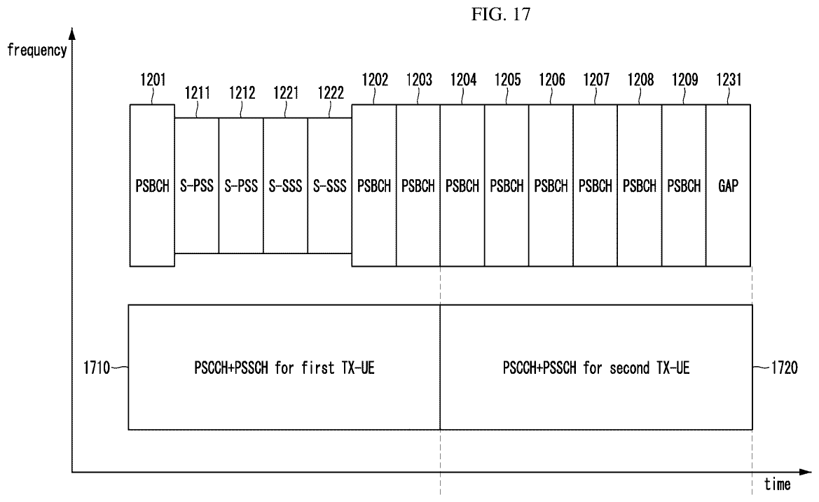

FIG. 17 is a conceptual diagram for describing a case where different TX-UEs respectively transmit PSCCH+PSSCHs according to an exemplary embodiment of the present disclosure.

In FIG. 17, the horizontal axis represents time resources and the vertical axis represents frequency resources. Since a transmission operation of FIG. 17 is performed by TX-UEs, the following description will assume that the TX-UEs are allocated resources and perform transmission as in FIG. 17.

When two TX-UEs need to transmit two different PSCCH+PSSCHs, each of the TX-UEs may be allocated a resource corresponding to the PSCCH+PSSCH it wishes to transmit. Here, being allocated a resource may mean being allocated the resource by a base station or being allocated the resource through reservation, as described above.

As illustrated in FIG. 17, the first TX-UE may be allocated a PSCCH+PSSCH resource 1710 for the first TX-UE, and the second TX-UE may be allocated a PSCCH+PSSCH resource 1720 for the second TX-UE. As illustrated in FIG. 17, the PSCCH+PSSCH resource 1710 for the first TX-UE and the PSCCH+PSSCH resource 1720 for the second TX-UE may be allocated to have a frequency resource different from a frequency resource in which S-SSB symbols are transmitted. The PSCCH+PSSCH resource 1710 for the first TX-UE may use the same time resource as a time resource from the first symbol to the seventh symbol among the S-SSB symbols, and the PSCCH+PSSCH resource 1720 for the second TX-UE may use a time resource from the eighth symbol of the S-SSB symbols to the last symbol, which is the GAP symbol 1231.

For the operation as in FIG. 17, each of the TX-UEs may operate a specific resource region based on specific ID information associated with the PSCCH+PSSCH transmitted by the corresponding TX-UE and the size of the time-frequency resource allocated for transmission of the PSCCH+PSSCH transmitted by the corresponding TX-UE.

As another method, a method other than the method of allocating PSCCH+PSSCH transmission resources in conjunction with the S-SSB resource as exemplified in FIG. 17 may be used. For example, each of the first TX-UE and the second TX-UE may use a specific resource region within a cell or RP-specifically configured resource region, and may transmit the PSCCH+PSSCH based on beam sweeping within the specific resource region.

As yet another method, the first TX-UE and the second TX-UE may be configured with a specific RP for beam sweeping-based PSCCH+PSSCH transmission, and perform beam sweeping-based PSCCH+PSSCH transmission within the RP.

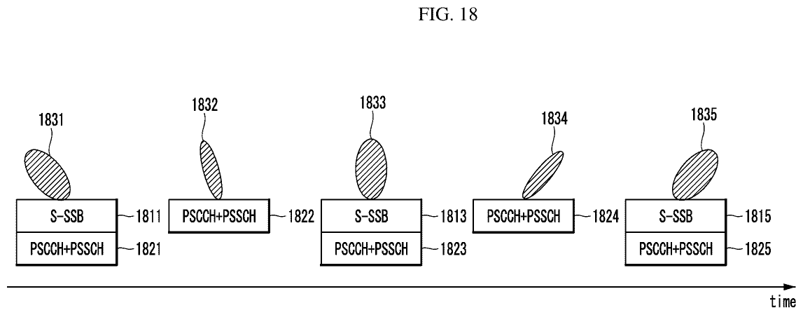

FIG. 18 is a conceptual diagram for describing a case of transmitting a PSCCH+PSSCH through a combination of S-SSB resource regions and specific PSCCH+PSSCH transmission resources according to an exemplary embodiment of the present disclosure.

As shown in FIG. 18, a case is exemplified where a TX-UE transmits PSCCH+PSSCHs 1821, 1823, and 1825 in the same time resources as S-SSBs 1811, 1813, and 1815 and transmits PSCCH+PSSCHs 1822 and 1824 between the S-SSB symbols 1811, 1813, and 1815 in a mixed manner.

The TX-UE may be configured to transmit the S-SSB symbols 1811, 1813, and 1815 based on beam sweeping. Therefore, as illustrated in FIG. 18, the TX-UE may transmit the first S-SSB 1811 through the first beam 1831, transmit the second S-SSB 1813 through the third beam 1833, and transmit the third S-SSB 1815 through the fifth beam 1835. Here, since the S-SSBs are transmitted through the first beam 1831, the third beam 1833, and the fifth beam 1835 based on beam sweeping, the beams may have different directions. In addition, the first beam 1831, the third beam 1833, and the fifth beam 1835 that transmit the respective S-SSBs may all have the same beam width.

In this case, the TX-UE may transmit the first PSCCH+PSSCH 1821, which is transmitted through the same time resource as the first S-SSB 1811, using the same first beam 1831 as the first S-SSB 1811, may transmit the third PSCCH+PSSCH 1823, which is transmitted through the same time resource as the second S-SSB 1813, using the same third beam 1833 as the second S-SSB 1813, and may transmit the fifth PSCCH+PSSCH 1825, which is transmitted through the same time resource as the third S-SSB 1815, using the same fifth beam 1835 as the third S-SSB 1815.

In addition, the TX-UE may transmit the second PSCCH+PSSCH 1822, which is transmitted between the first S-SSB 1811 and the second S-SSB 1813, and transmit the fourth PSCCH+PSSCH 1824, which is transmitted between the second S-SSB symbol and the third S-SSB 1815. In this case, the TX-UE may use each of the beams 1832 and 1834 for transmitting the second PSCCH+PSSCH 1822 and the fourth PSCCH+PSSCH 1824 as a beam configured in a dedicated resource set allocated for PSCCH+PSSCH transmission.

For example, a beam width of the beam configured in the dedicated resource set allocated for PSCCH+PSSCH transmission may have a beam width that is the same as or different from a beam width of a beam for S-SSB transmission. In the example of FIG. 18, the beam width of the beam configured in the dedicated resource set allocated for PSCCH+PSSCH transmission may be narrower than the beam width of the beams 1831, 1833, and 1835 for S-SSB transmission.

In addition, a beam direction of the beam configured in the dedicated resource set allocated for PSCCH+PSSCH transmission may be the same as or different from a beam direction of at least one of the beams for S-SSB transmission. The example of FIG. 18 illustrates a case where a beam direction different from those for S-SSB transmission is used. In particular, FIG. 18 illustrates a form of utilizing a beam having a direction between beam directions for S-SSB transmission. This will be described in more detail as follows.

The beam direction of the second beam 1832 transmitting the second PSCCH+PSSCH 1822 transmitted between the first S-SSB 1811 and the second S-SSB 1813 may be configured to have a direction between the first beam 1831 and the third beam 1833. In addition, the beam direction of the fourth beam 1834 transmitting the fourth PSCCH+PSSCH 1824 transmitted between the second S-SSB 1813 and the third S-SSB 1813 may be configured to have a direction between the third beam 1833 and the fifth beam 1835.

Meanwhile, the case of FIG. 18 corresponds to a case where the beam sweeping resource is greater than the resource transmitting the S-SSB symbols, and may be applied when a reception probability at the RX-UE is to be increased by transmitting more PSCCH+PSSCHs through the beam sweeping resource.

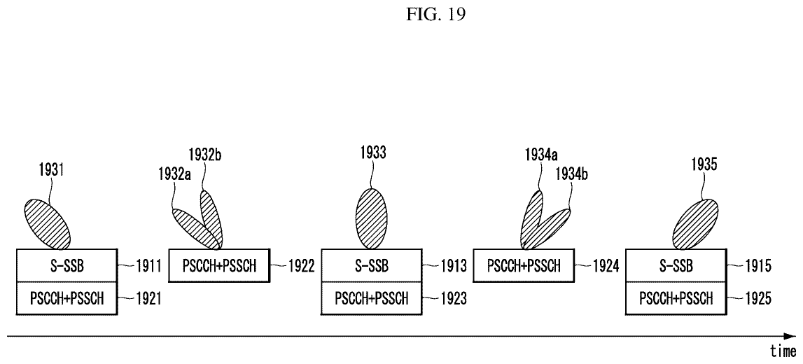

FIG. 19 is a conceptual diagram for describing a case of transmitting a PSCCH+PSSCH through a combination of S-SSB resource regions and specific PSCCH+PSSCH transmission resources according to another exemplary embodiment of the present disclosure.

As shown in FIG. 19, a case is exemplified where a TX-UE transmits PSCCH+PSSCHs 1921, 1923, and 1925 transmitted in the same time resources as S-SSBs 1911, 1913, and 1915 and transmits PSCCH+PSSCHs 1922 and 1924 between the S-SSBs 1911, 1913, and 1915 in a mixed manner.

The TX-UE may be configured to transmit the S-SSB symbols 1911, 1913, and 1915 based on beam sweeping. Therefore, as illustrated in FIG. 19, the TX-UE may transmit the first S-SSB 1911 through the first beam 1931, the second S-SSB 1913 through the third beam 1933, and the third S-SSB 1915 through the fifth beam 1935. In other words, the S-SSBs may be transmitted in the same scheme as in FIG. 18.

In addition, the TX-UE may transmit the first PSCCH+PSSCH 1921, which is transmitted through the same time resource as the first S-SSB 1911, using the same first beam 1931 as the first S-SSB 1911, may transmit the third PSCCH+PSSCH 1923, which is transmitted through the same time resource as the second S-SSB 1913, using the same third beam 1933 as the second S-SSB 1913, and may transmit the fifth PSCCH+PSSCH 1925, which is transmitted through the same time resource as the third S-SSB 1915, using the same fifth beam 1935 as the third S-SSB 1915.

In addition, the TX-UE may transmit the second PSCCH+PSSCH 1922 between the first S-SSB 1911 and the second S-SSB 1913, and may transmit the fourth PSCCH+PSSCH 1924 between the second S-SSB 1913 and the third S-SSB 1915. In this case, the TX-UE may transmit the second PSCCH+PSSCH 1922 using two different beams 1932a and 1932b, and may also transmit the fourth PSCCH+PSSCH 1924 using two different beams 1934a and 1934b.

The example of FIG. 19 differs from the example of FIG. 18 only in the scheme that the second PSCCH+PSSCH 1922 and the fourth PSCCH+PSSCH 1924 are transmitted. Therefore, the TX-UE may transmit each of the second PSCCH+PSSCH 1922 and the fourth PSCCH+PSSCH 1924 using two beams (1932a and 1932b, or 1934a and 1934b).

The TX-UE may be operated by allocating time-frequency resources for PSCCH+PSSCH transmission equal to the number of beams used, so that each of the second PSCCH+PSSCH 1922 and the fourth PSCCH+PSSCH 1924 uses two beams (1932a and 1932b, 1934a and 1934b).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first user equipment (UE), comprising:
transmitting a first physical sidelink control channel (PSCCH) to a second UE in a beam sweeping scheme, the first PSCCH including beam identification information and physical sidelink feedback channel (PSFCH) resource information;
receiving a PSFCH from the second UE based on the PSFCH resource information;
performing beam pairing by determining a transmission beam and a reception beam to be used for sidelink communication based on transmission beam indication information included in the received PSFCH and a beam through which the PSFCH is received; and
performing sidelink communication with the second UE through the transmission beam and the reception beam which are paired through the beam pairing.

2. The method according to claim 1, wherein the PSFCH resource information includes mapping information between each beam of the first UE and one reserved PSFCH resource or mapping information between beams of the first UE and one reserved PSFCH resource.

3. The method according to claim 1, wherein the beam sweeping scheme is performed based on beam sweeping configuration information including at least one of a number of times of performing beam sweeping or a periodicity at which the beam sweeping is performed.

4. The method according to claim 1, wherein the transmission beam indication information includes information of bit(s) corresponding to an index for identifying a beam through which the first PSCCH is transmitted or a sequence for identifying a beam through which the first PSCCH is received.

5. The method according to claim 1, further comprising: transmitting data to be transmitted to the second UE through a physical sidelink shared channel (PSSCH) using all of beams being swept.

6. The method according to claim 1, further comprising: in response to an error existing in the received PSFCH, transmitting a second PSCCH to the second UE in a beam sweeping scheme using a greater number of beams than a previous period based on beam sweeping configuration information.

7. The method according to claim 1, further comprising:
checking a number of beam sweeping resources and a number of beams to be swept;
in response to the number of the beam sweeping resources being smaller than the number of the beams to be swept, dividing the beams to be swept into a plurality of groups based on the beam sweeping resources; and
transmitting the first PSCCH to the second UE by sequentially performing beam sweeping using the respective plurality of groups through the beam sweeping resources.

8. A method of a first user equipment (UE), comprising:
determining a beam sweeping resource for a first physical sidelink control channel (PSCCH #1) and a first physical sidelink shared channel (PSSCH #1) to be transmitted to a second UE;
determining a transmission resource to have a same time resource as at least some symbols of a sidelink synchronization signal block (S-SSB) transmitted using the determined beam sweeping resource in a beam sweeping scheme; and
transmitting the PSCCH #1 and the PSSCH #1 to the second UE in the determined transmission resource in a beam sweeping scheme,
wherein a beam for transmitting the PSCCH #1 and the PSSCH #1 is same as a beam for transmitting symbols of the S-SSB.

9. The method according to claim 8, wherein the transmission resource is composed of symbols excluding symbols in which a synchronization signal is transmitted among the symbols of the S-SSB.

10. The method according to claim 8, wherein when the first UE is not a UE transmitting the S-SSB, the PSCCH #1 and the PSSCH #1 are transmitted to the second UE using a same frequency resource as the S-SSB.

11. The method according to claim 8, further comprising:
in response to existence of a PSCCH #2 and PSSCH #2 to be transmitted to a third UE, determining a second transmission resource of the PSCCH #2 and the PSSCH #2 so as to have a same time resource as one or more symbols that do not correspond to the PSCCH #1 and the PSSCH #1 among the symbols of the S-SSB; and
transmitting the PSCCH #2 and the PSSCH #2 to the third UE using the second transmission resource,
wherein a beam for transmitting the PSCCH #2 and the PSSCH #2 is same as a beam through which the S-SSB is transmitted.

12. The method according to claim 8, further comprising: in response to a number of required transmissions of the PSCCH #1 and the PSSCH #1 being greater than a number of S-SSBs, transmitting the PSCCH #1 and the PSSCH #1 by performing additional beam sweeping in a time resource different from transmission resources for S-SSBs.

13. The method according to claim 12, wherein in the additional beam sweeping for the PSCCH #1 and the PSSCH #1, a beam width and a beam direction are determined based on values set in a dedicated resource set allocated for transmission of the PSCCH #1 and the PSSCH #1.

14. The method according to claim 13, wherein two or more different beams are configured as additional beams for the additional beam sweeping for the PSCCH #1 and the PSSCH #1.

15. A first user equipment (UE) comprising a processor, wherein the processor causes the first UE to perform:
transmitting a first physical sidelink control channel (PSCCH) to a second UE in a beam sweeping scheme, the first PSCCH including beam identification information and physical sidelink feedback channel (PSFCH) resource information;
receiving a PSFCH from the second UE based on the PSFCH resource information;
performing beam pairing by determining a transmission beam and a reception beam to be used for sidelink communication based on transmission beam indication information included in the received PSFCH and a beam through which the PSFCH is received; and
performing sidelink communication with the second UE through the transmission beam and the reception beam which are paired through the beam pairing.

16. The first UE according to claim 15, wherein the PSFCH resource information includes mapping information between each beam of the first UE and one reserved PSFCH resource or mapping information between beams of the first UE and one reserved PSFCH resource.

17. The first UE according to claim 15, wherein the beam sweeping scheme is performed based on beam sweeping configuration information including at least one of a number of times of performing beam sweeping or a periodicity at which the beam sweeping is performed.

18. The first UE according to claim 15, wherein the transmission beam indication information includes information of bit(s) corresponding to an index for identifying a beam through which the first PSCCH is transmitted or a sequence for identifying a beam through which the first PSCCH is received.

19. The first UE according to claim 15, wherein the processor further causes the first UE to perform: transmitting data to be transmitted to the second UE through a physical sidelink shared channel (PSSCH) using all of beams being swept.

20. The first UE according to claim 15, wherein the processor further causes the first UE to perform:
checking a number of beam sweeping resources and a number of beams to be swept;
in response to the number of the beam sweeping resources being smaller than the number of the beams to be swept, dividing the beams to be swept into a plurality of groups based on the beam sweeping resources; and
transmitting the first PSCCH to the second UE by sequentially performing beam sweeping using the respective plurality of groups through the beam sweeping resources.
